(19) United States
(12) Patent Application Publication
(10) Pub. No.: US 2024/0313250 A1
(43) Pub. Date: Sep. 19, 2024

(54) METHOD AND MACHINE FOR MANUFACTURING ELECTRICAL ENERGY STORAGE DEVICES

(71) Applicant: P.I.T. S.R.L., Granarolo Dell’Emilia (BO) (IT)

(72) Inventor: Mario SPATAFORA, Granarolo Dell’Emilia (BO) (IT)

(21) Appl. No.: 18/575,528

(22) PCT Filed: Jul. 1, 2022
(86) PCT No.: PCT/IT2022/050193

§ 371 Date: Dec. 29, 2023

(30) Foreign Application Priority Data
Jul. 2, 2021 (IT) 102021000017600

(51) Int. Cl. H01M 10/04; B65H 18/10

(52) U.S. Cl. CPC H01M 10/0404; B65H 18/10; B65H 2701/19

(57) ABSTRACT

The machine for manufacturing storage devices includes means for feeding a plurality of tape elements, forming at least one anode, one cathode and one separating element interposed between said anode and cathode, to a group of temporary storage rollers and means for cutting to size of respective portions of given length of said tape elements wound on said temporary storage rollers. A winding mandrel, having an axis of rotation parallel to the axes of said temporary accumulation rollers is rotatable to wind in a cylindrical or similar shape said portions of given length of said tape elements superimposed to form a cell of an accumulation device.

### TECHNICAL FIELD

The present invention relates to a process for making electrical energy storage devices, such as cylindrical cell electric batteries and the like, as well as a machine for implementing such a process.

### PRIOR ART

It is currently known, in the field of electrical energy storage devices, the use of electric batteries consisting of a plurality of superimposed tape elements, forming at least one anode, one cathode and one separating element interposed between said anode and cathode. According to a frequent used embodiment, said superimposed tape elements are wound to form a cylindrical or similarly shaped cell, which is for example oval or prismatic.

In order to make the aforementioned electric batteries, a method is known which provides for feeding the tape elements forming anode, cathode and one or more separator elements into an area in which the same tape elements are superimposed on each other. The tape elements are provided in the form of flexible tapes which are unwound from respective reels. The superimposed tapes are associated, at the free end, with a mandrel that is rotatable according to its longitudinal axis. The rotation of the mandrel determines the winding of the superimposed tapes thereon. When a portion of given length of the tapes has been wound on the winding mandrel, suitable cutting means intervene to cut the same tapes, subsequently fixed by means of adhesive tape or other similar systems, for example by heat sealing.

According to a known embodiment, the winding mandrel is formed by two halves, for example of semi-cylindrical or prismatic shape, adapted to be alternatively moved close or away from each other between a spaced position and an approached position. In the spaced position, it is possible to insert, between the two halves of the winding mandrel, the free end of the portions of given length of the tape elements; in the approached position, the tightening of said free ends of the tape elements is carried out, enabling the rotation of the winding mandrel to wind the same rolled tape elements to form the cylindrical cell. Alternatively, the tape elements can be associated with the winding mandrel by suitable suction means or heat sealing to a plastic element previously supplied to the mandrel.

An electric battery of this type is shown, for example, in European Patent EP 0 494 147.

U.S. Patent Application US 20170133703 shows an apparatus for winding superimposed tape elements of a cylindrical cell battery.

The winding of the tape elements on a winding mandrel formed of two halves, movable relative to each other to clamp the free end of said tape elements, is shown for example in U.S. Pat. Nos. 4,975,095 and 5,370,711 and International Patent Application WO 98/264662.

The described process for winding tape materials in cylindrical form has long been widely standardized, in the field of manufacturing electrical energy storage devices. However, this process takes a relatively long time, due to the length of the superimposed tapes to be wound and the small radial dimensions of the winding mandrel.

By way of example, the diameter of the winding mandrel currently changes between 3 and 12 mm and allows a section of the tape materials between 9 and 26 mm to be wound in the first rounds, on each round. Taking into account having to wind a portion of superimposed tapes for example of the length of at least 3 m, currently the fastest machines are able to perform a single winding in 1.3 sec. time.

In practice, the fastest machines currently in use are able to perform about 25 windings per minute with a length of 3 m.

Conversely, current needs require machines capable of ensuring the achievement of a high production speed, also in relation to the need to create cylindrical cell electric batteries and the like with a greater length of wound material.

### SUMMARY OF THE INVENTION

The aim of the present invention is to solve the aforementioned problems, by devising a process that permits to optimally wind the superimposed tape elements forming the anode, the cathode and at least one separating element in the production of electrical energy storage devices, such as, for example, cylindrical cell electric batteries and the like.

As part of this aim, it is a further object of the invention to provide a process for manufacturing cylindrical cell electric batteries and the like that ensures the achievement of a high production speed.

Another object of the invention is to provide a method for manufacturing cylindrical cell electric batteries and the like that allows windings having a greater length of the wound material to be carried out.

A further object of the invention is to provide a machine for implementing such a process with a simple construction and functional design, reliable operation, versatile use, as well as a relatively economical cost.

The aforementioned objects are achieved, according to the present invention, by the process and by the machine for manufacturing electrical energy storage devices, such as for example cylindrical cell electric batteries and the like, according to the present application.

The process for manufacturing electrical energy storage devices comprises the steps of
a. feeding with continuous motion a plurality of tape elements, forming at least one anode, one cathode and one separator element interposed between said anode and cathode;
b. winding said tape elements on respective temporary storage rollers;
c. cutting to size respective portions of given length of said tape elements (10) wound on said temporary storage rollers;
d. arranging said temporary storage rollers carrying said respective portions of given length of said tape elements at a winding mandrel;
e. associating a free end of said portions of given length of said tape elements (10) to said winding mandrel (41);
f. rotating said winding mandrel to wind said portions of given length of said tape elements superimposed on each other, on the same winding mandrel;
g. finishing the winding of said portions of given length of the tape elements (10) superimposed on said winding mandrel (41) to form a cell (100) of the electrical energy storage device, until said portions of given length of said tape elements (10) are completely wound off said temporary storage rollers (30).

Advantageously, said step of arranging said temporary storage rollers at said winding mandrel provides for moving at least a part of said temporary storage rollers from a position away from said winding mandrel, in which the winding of said tape elements on said respective temporary storage rollers is performed, to a position next to the same winding mandrel.

Advantageously, the process further provides for
initially associating to said winding mandrel a free end of said portion of given length of at least one said tape element (11, 13) forming a separator element;
rotating said winding mandrel to start the winding of said portion of given length of at least one said tape element forming a separator element on the same winding mandrel;
associating said winding mandrel with the free ends of said portions of given length of said tape elements forming at least one anode and one cathode.

The present invention also relates to a machine for manufacturing electrical energy storage devices, comprising
means for feeding with continuous motion a plurality of tape elements, forming at least one anode, one cathode and one separator element interposed between said anode and cathode;
at least one group of temporary storage rollers capable of receiving and winding respectively said tape elements (10) fed by said feeding means (2);
means for cutting to size respective portions of given length of said tape elements wound on said temporary storage rollers;
at least one winding mandrel rotatable to wind said portions of given length of said superimposed tape elements;
means for arranging said temporary storage rollers at said winding mandrel;
means for associating a free end of said portions of given length of said tape elements to said winding mandrel, to wind said portions of given length of said superimposed tape elements in cylindrical manner;
discharging means configured for separating the cell from the electrical energy storage device so manufactured from said winding mandrel.

Preferably said winding mandrel has an axis of rotation placed parallelly to the respective axes of rotation of said temporary storage rollers.

Preferably said winding mandrel is rotatable to cylindrically wind said portions of given length of said superimposed tape elements.

Advantageously, the machine comprises a plurality of groups of temporary storage rollers adapted respectively to receive and wind in sequence said tape elements fed by said feeding means.

This solution permits to complete the winding on a winding mandrel of the respective portions of given length of said tape elements, being unwound by a group of temporary storage rollers, while at the same time further respective portions of given length of the tape elements are wound on a further group of temporary storage rollers.

Preferably, said winding mandrel comprises a pair of bodies of complementary shape adapted to be alternately moved close to each other and away one from another between a spaced position for inserting within them of a free end of at least one of said portions of given length of said tape elements and an approached position for clamping said free end of said at least one of said portions of given length of the tape elements, before the rotation of the winding mandrel itself to perform the winding of the tape elements.

Preferably said pair of complementary shaped bodies comprises a pair of semi-cylindrical bodies having opposed flat surfaces adapted to be clamped against each other in said adjacent position.

Preferably said winding mandrel is operable in axial motion between a retracted position and an advanced position.

Advantageously, said means for cutting to size is adapted to cooperate with respective exchanger rollers adapted to receive said tape elements from said feeding means and to transfer the same tape elements respectively to said temporary storage rollers.

Preferably, said exchanger rollers have respectively a pair of depressed zones adapted to retain respective free ends of said tape elements placed upstream and downstream of the cutting line defined by said means of cutting to size, following the cutting of said portions of given length of the same tape elements.

Preferably, said means adapted to provide said temporary storage rollers at said winding mandrel comprise gripping means arranged respectively at said exchanger rollers and movable between a gripping position of said free ends of said portions of given length of the tape elements placed downstream of the cutting line defined by said cutting-to-size means and a release position of the same free ends to said winding mandrel.

Preferably said temporary accumulation rollers have a respective gripping zone placed under vacuum adapted to retain the leading end of said tape elements to be wound.

According to another advantageous aspect of the invention, the machine comprises, downstream of said feeding means, buffering devices or buffers adapted to house respectively a variable reserve portion of said tape elements.

Preferably, each of said buffer devices comprises a pair of surfaces, developed facing each other to accompany the unwinding of said respective tape elements forming a loop therebetween and associated with suction means adapted to depress a section of the surfaces themselves, to hold adherently the same tape elements sliding thereon.

Preferably said tape elements form a loop between said pair of surfaces of each one of said buffer devices.

Preferably said discharge means comprise a rotatable distributor member adapted to transfer in ordered succession said cells of the electrical energy storage device to a belt conveyor.

### BRIEF DESCRIPTION OF THE DRAWINGS

The details of the invention will become more apparent from the detailed description of a preferred embodiment of the machine for manufacturing cylindrical cell electric batteries, illustrated by way of example in the accompanying drawings, wherein:

FIG. 1 shows a side view of the machine for manufacturing electric cylindrical cell batteries according to the present invention;

FIG. 2 shows an enlarged side view of an operative zone of the machine in which the feeding and winding in a cylindrical form of portions of given length of said rolled tape elements is carried out to form said cylindrical cells; and

FIGS. 3, 4, 5 and 6 respectively show detailed views of portions of the machine operative zones.

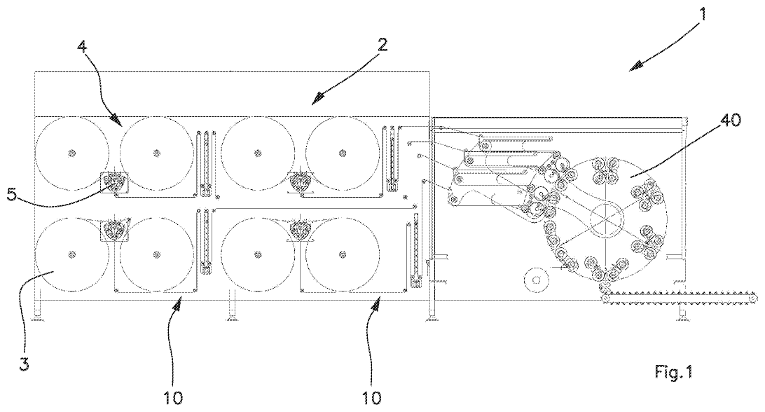

### DETAILED DESCRIPTION

With particular reference to these figures, the machine for manufacturing electrical energy storage devices, such as in particular cylindrical cell electric batteries and the like according to the invention, has been indicated in whole with the reference numeral 1.

The machine comprises means 2 for feeding tape materials consisting of a plurality of tape elements 10, forming one anode, one cathode and at least one dielectric material separator element. The tape elements 10 are fed respectively in the form of flexible tapes intended to be superimposed and wound in a cylindrical shape. The tape elements 10 are provided on respective reels 3.

In the illustrated example, the tape elements 10 intended for manufacturing each electric battery comprise a pair of separating elements 11, 13 interposed between the elements 12, 14 forming anode and cathode.

The machine comprises a unwinding assembly 4 of the reels 3 of tape materials, rotated with continuous motion according to parallel horizontal axes. Preferably, each unwinding station of the machine provides for a pair of reels 3 to be arranged for each of the tape materials 10 to be unwound, so as to allow automatic change, through a special joining device 5, when each single reel 3 of each pair is exhausted. In this way, the continuity of operation of the machine is ensured.

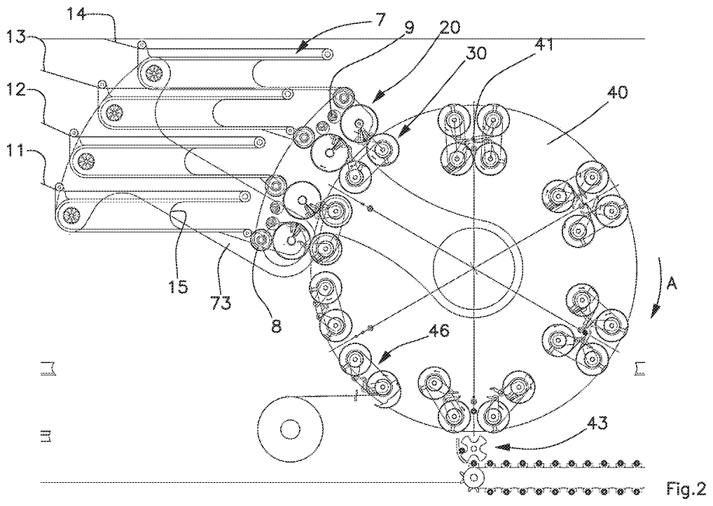

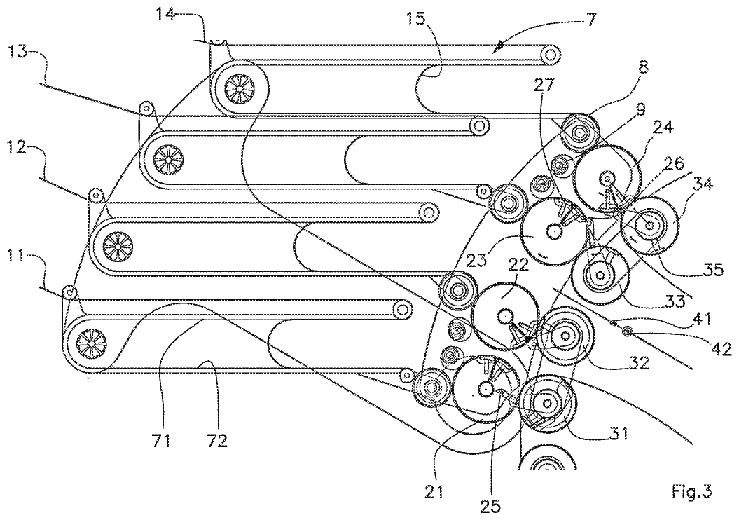

The tape elements 10 that are unwound from the relative reels 3 are directed, by means of special diverter rollers, to respective buffer devices 7, also known as buffers, adapted to house a variable reserve portion of each tape, to compensate for a different speed of the same tape upstream and downstream of said buffer device 7 (see FIGS. 2 and 3).

Each buffer 7 comprises a pair of surfaces 71, 72, which develop in front of each other, so as to accompany the unwinding of the relative tape. The surfaces 71, 72 are suitably perforated and associated with suction means adapted to depress a section of the surfaces themselves, to retain adherently the sliding tape thereon.

In practice, each tape 10 unwinds on the first surface 71 of the buffer and detaches therefrom, forming a loop 15, to pass on the second surface 72 of the buffer, provided at the end with an unwinding roller 8. In essence, the buffer 7 is able to decouple the input feeding step from the subsequent superimposing and winding step of the tape materials 10, as specified below.

At the exit from the unwinding rollers 8, the tape elements 10 engage corresponding exchanger rollers 20 adapted to cooperate with appropriate cutting-to-size means 9. In particular, the tape elements 11, 12, 13, 14 engage respectively the exchanger rollers 21, 22, 23, 24.

As specified below, said cutting means 9 is adapted to cut to size respective portions of given length of said tape elements 10. In the context of the present invention, it is understood that said given length of said tape elements 10 does not change, unless any corrections that may intervene in use.

When cutting each tape element 10, the portions 16, 17 upstream and downstream of the cutting line are held at respective zones 26, 27 placed under vacuum of the exchanger rollers 20; the tape material downstream of the cutting line, i.e. substantially the rearmost of said portions of given length of the rolled tape elements, is subsequently taken by gripping means 25 consisting of a rotatable member, called vacuum head, arranged at each of the exchanger rollers 20. The vacuum head 25 in turn has a gripping area adapted to be placed under vacuum.

It should be noted that the portions cut from the respective tape do not necessarily have the same given length, but each portion may have its own given length.

The tape elements 10 are fed by the exchanger rollers 20 to corresponding temporary storage rollers 30 rotatable according to parallel horizontal axes, so as to wind said tape elements 10 on the same temporary storage rollers 30. In particular, the tape elements 11, 12, 13, 14, forming the anode, cathode and separating elements of the electric battery, are wound respectively on the temporary storage rollers 31, 32, 33, 34.

It should be noted that the aforementioned cutting of the tape material on the exchanger rollers 20 takes place in a position such as to guarantee respective portions of given length of said tape elements 10 wound on the temporary storage rollers 30.

The temporary storage rollers 30 have a gripping zone 35 placed under vacuum adapted to retain the leading end of the respective tape elements 10 to be wound.

According to a preferred embodiment of the machine, the temporary storage rollers 30 are brought to the periphery of a rotatable member 40 adapted to be driven according to a horizontal axis parallel to the axis of the unwinding rollers 20 and of the temporary storage rollers 30, with continuous motion, in the direction indicated with arrow A.

In particular, at the time of transfer of the tape elements 10, the temporary storage rollers 30 are arranged aligned with each other along a concentric arc of circumference to the axis of rotation of the rotatable member 40.

In the illustrated example, for the winding of the tape elements 10 intended for manufacturing each electric battery, there are four temporary storage rollers 31, 32, 33, 34.

More specifically, the first and third temporary storage rollers 31, 33, according to the direction A of rotation of the rotatable member 40, are intended for winding the separator tapes 11, 13; while the second and fourth temporary storage rollers 32, 34 are intended for winding the anode and cathode tapes 12, 14.

In axis with the temporary accumulation rollers 30, respective levers 36 are mounted angularly rotatable, bearing said vacuum gripping heads 25 pivoted at the free end.

It should be noted that the group of buffers 7 with the relative unwinding rollers 8 and exchanging rollers 20 is suitably carried by an oscillating frame 73 on a transversal vertical plane, preferably perpendicular to the rotation axes of the rollers 8, 20. In particular, the oscillating frame 73 is pivoted on the same axis of rotation as the rotatable member 40. In this way, the exchanger rollers 20 are able to follow the movement of the rotatable member 40.

During the oscillating movement of the frame 73, the exchanger rollers 20 are constantly tangent to the temporary storage rollers 30. When the frame 73 reaches the upper point of its stroke, the feeding of the tape elements 10 to the temporary storage rollers 30 stops instantaneously and the oscillating frame 73 returns to the lower point of its stroke, where the end of the tape elements 10 held by the exchanger rollers 20 upstream of the cutting means 9 is transferred to a new group of four temporary accumulation rollers 30, intended for the manufacturing of a subsequent cylindrical cell.

Certainly, the stopping of the frame 73 occurs at the moment in which the cutting of the tape elements 10 is performed.

During the passage from the feeding of a group of four storage rollers 30 to the next one, the feeding of the tapes 10 by the respective reels 3 is not interrupted, due to the continuous rotational movement of the same reels 3, but rather the incoming material fills the loops 15 of the buffers 7 which had previously been emptied. In a suitable phase relationship, the empty temporary storage rollers 30, after having gripped the tape material 10, accelerate their rotation speed to empty again the loops 15 of the buffers 7.

Advantageously, the rotatable member 40 peripherally carries a plurality of said groups of temporary storage rollers 30, regularly distributed, designed to perform in succession the winding of successive portions of tape elements 10. In the illustrated case, the rotatable member 40 peripherally carries six groups of temporary storage rollers 30; however, it is possible to provide a different number of such groups of temporary storage rollers, according to needs.

The first and fourth provisional storage rollers 31, 34 are respectively carried by an arm 37 rotatable angularly with respect to the rotation axis of the same temporary storage rollers 31, 34. After the loading step on the temporary storage rollers 30 of the respective portions of given length of said tape elements 10, during the subsequent advance of the rotatable member 40, the arms 37 are rotated in a suitable phase relationship, according to opposite directions, for an amplitude of about 90° or slightly less, so as to bring the first and fourth temporary accumulation rollers 31, 34 towards the inside of the rotatable member, substantially forming the vertices of a quadrilateral with the second and third temporary storage roller 32, 33, which instead have a fixed position on the rotatable member 40.

At the center of this quadrilateral, i.e. at the intersection of the diagonals of the quadrilateral, a winding mandrel 41 is arranged, adapted to be driven in rotation, in suitable phase relationship with the movement of the rotatable member 40, to perform the winding in cylindrical form of the superimposed tape materials 10. As explained below, the winding mandrel 41 is also operable in axial motion between a retracted position and an advanced position.

The winding mandrel 41 is formed in a known way of two halves adapted to be alternately moved close to each other and away from each other between a spaced position for inserting within them a free end of said portions of given length of said tape elements 10 and an approached position for clamping said free ends of the tape elements 10, allowing the same winding mandrel 41 to rotate in order to wind the tape elements 10.

In the shown case, the two halves of the winding mandrel 41 have semi-cylindrical shape. However, it is possible to provide that the two halves of the winding mandrel 41 have different shape, for example oval or prismatic shape. In this case, of course, the cell will have a corresponding oval or prismatic shape.

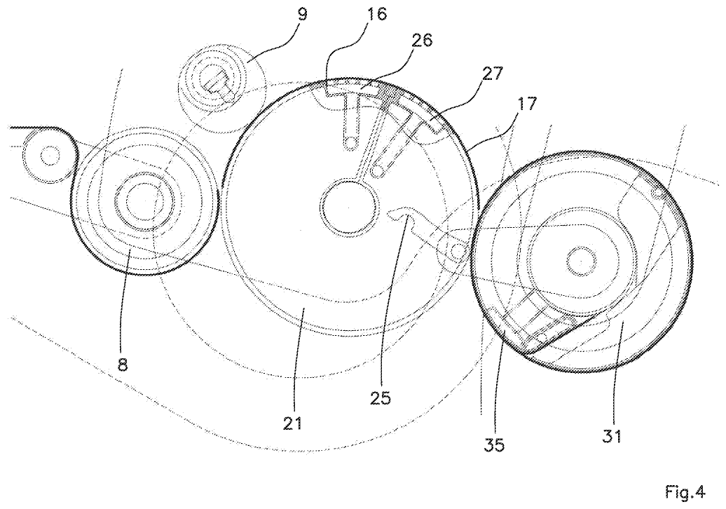

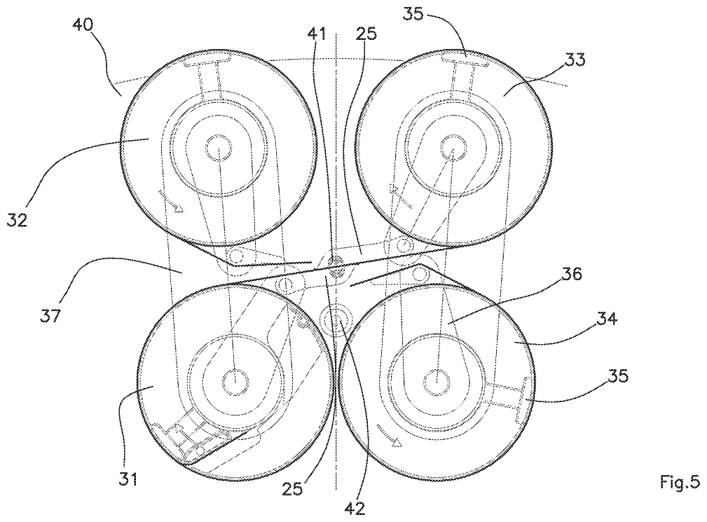

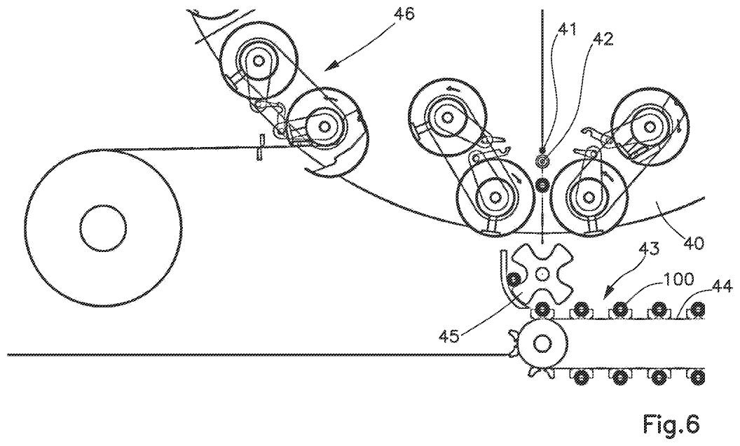

To this end, an appropriate angular rotation of the vacuum heads 25 gripping the free end of said portions of given length of the separator tapes 11, 13, wound on the first and third temporary storage rollers 31, 33, is adapted to arrange the same free ends in a position of mutual alignment, according to a straight line tangent to the separator tapes wound on the temporary storage rollers 30 (FIG. 4).

In this step of arranging the separator tapes 11, 13, the winding mandrel 41 is arranged in a retracted position, with the two semi-cylindrical halves arranged in a spaced position. Once the free ends of the separator tapes 11, 13 have been aligned, the winding mandrel 41 is moved to an advanced position, so as to engage the free ends of the separator tapes 11, 13, still retained by the respective vacuum gripping heads 25, between the two semi-cylindrical halves. The two semi-cylindrical halves of the winding mandrel 41 are then brought closer to tighten the free ends of the separator tapes 11, 13.

The operation in rotation of the winding mandrel 41, in suitable phase relationship with the release of the separator tapes 11, 13 by the vacuum gripping heads 25 makes the winding of the tapes start.

At the same time, the free ends of the anode and cathode tapes 12, 14, wound on the second and fourth temporary storage rollers 32, 34, are approached, by means of an angular rotation of the respective vacuum gripping heads 25, to the rotating winding mandrel 41. In this way, the anode and cathode tapes 12, 14 are also associated with the winding mandrel 41, in positions interposed between the separating tapes 11, 13.

A contrast roller 42 is pressed against the tape material 10 being wound on the winding mandrel 41, which is adapted to prevent the entry of air between the superimposed tapes 10, as well as to prevent the unwinding of the superimposed tapes 10 just wound on the winding mandrel 41.

At the end of the winding step of the tape elements 10 on the winding mandrel 41, which extends for example by a rotation of the rotating member 40 of about half a turn, the superimposed tapes 10 wound in a cylindrical shape are fixed by the application of a portion of adhesive tape or other suitable fixing system.

The cylindrical cell 100 so created is subsequently released into an unloading zone on special removal means 43. In the case shown by way of example, the removal means comprises a rotating distributor 44 adapted to transfer in orderly succession the cylindrical cells 100 to a belt conveyor 45.

After the unloading of the produced cylindrical cell 100, the rotation of the rotatable member 40 brings the group of temporary storage rollers 30 at a loading station 46 of the adhesive tape. A portion of adhesive tape is taken from the first storage roller of the group of temporary storage rollers 30 and arranged to be partially fixed to the separator tape 11 at the beginning of the winding of the tape element 11 on the first temporary storage roller 31.

In this way, the fixing of the superimposed tapes 10 wound in a cylindrical shape on the winding mandrel 41 takes place by means of the remaining part of the portion of adhesive tape that has not been fixed to the separating tape 11 that carries it. Of course, it is necessary that the separating tape 11 carrying the portion of adhesive tape is the outermost one.

The operation of the machine for manufacturing electrical energy storage devices, such as cylindrical cell electric batteries and the like, is easily understandable from the following description.

The tape elements 10 constituting the anode, the cathode and the separating elements of the electrical batteries are carried out with continuous motion from the respective reels 3.

The tape elements 10 are directed, by means of special diverter rollers, to respective buffer devices or buffers 7 that house a variable reserve portion 15 of each tape, to compensate, if necessary, for the different speed of the same tape upstream and downstream of the buffer device 7. Said variable reserve portion 15 consists in practice of a loop formed by the tape elements 10 between the opposite surfaces 71, 72 of the respective buffer devices 7.

At the exit from the buffer devices 7, by means of special unwinding rollers 8, the tape elements 10 are unwound on respective exchanger rollers 20 and are then wound on the corresponding temporary storage rollers 30, driven in rotation with continuous motion.

In particular, the leading end of the tape elements 10 is initially retained on the gripping zone 35 placed under vacuum of the corresponding temporary storage roller 30, on which the tape material is then wound.

The winding of the tape elements 10 on the corresponding temporary storage rollers 30 takes place during the rotation of the rotatable member 40 which peripherally carries the same temporary storage rollers 30. During this step, the temporary storage rollers 30 are arranged aligned with each other along a concentric arc of circumference to the axis of rotation of the rotatable member 40.

More specifically, on the first and third temporary storage rollers 31, 33, according to the direction A of rotation of the rotatable member 40, the separating tapes 11, 13 are wound; while on the second and fourth temporary accumulation rollers 32, 34 the anode and cathode tapes 12, 14 are wound.

In a suitable phase relationship with the rotation of the rotatable member 40 that winds the temporary storage rollers 30, the oscillating frame 73 that carries the group of buffers 7 with the relative unwinding rollers 8 and exchanger rollers 20 rotates angularly according to its axis, coinciding with the axis of rotation of the rotatable member 40. In this way, the exchanger rollers 20 are able to follow the movement of the rotatable member 40.

In practice, during the oscillating movement of the frame 73, the exchanger rollers 20 are constantly tangential to the temporary storage rollers 30 and have zero relative speed with respect thereto.

When the respective portions of given length of the tape elements 10 are wound on the temporary storage rollers 30, the cutting means 9 cooperating with the exchanger rollers 20 cut to size the same tape elements 10.

When cutting each tape element 10, the upstream and downstream portions of the cutting line are retained at respective zones 26, 27 placed under vacuum of the exchanger rollers 20. The tail end of the portion of given length of the tape material placed downstream of the cutting line is then taken by the vacuum head 25, arranged at each of the temporary storage rollers 30, releasing the vacuum on the exchanger rollers to facilitate their release; the end of the portion of the tape material placed upstream of the cutting line, on the other hand, continues to be held by the exchanger rollers 20 until they are associated with subsequent storage rollers, on which further portions of given lengths of said tape elements 10 are then wound.

At the same time, at the end of the winding of the tape elements 10 on the temporary storage rollers 30 and the cutting of said portions of given length of the same tape elements 10, the oscillating frame 73 carrying the exchanger rollers 20 stops and returns to the lower point of its own stroke, where the ends of the tape materials 10 held by the exchanger rollers 20 are associated with a new group of four provisional storage rollers 20, intended for making the next cylindrical cell.

As mentioned, during the step of passing from the feeding of a group of four temporary storage rollers 30 to the next one, the tape elements 10 fed by the respective reels 3 fill the loops of the buffers 7; in suitable phase relationship, the empty temporary storage rollers 30, after having grabbed the head end of the tape elements 10, accelerate their rotation speed to empty the loops of the buffers 7 again.

During the subsequent rotation of the rotatable member, the tape elements 10 are transferred from the temporary storage rollers 30 to the winding mandrel 41.

To this end, the arms 37 which carry the first and fourth temporary storage rollers 31, 34 are rotated, in opposite directions, for an amplitude of about 90°, so as to carry the same first and fourth temporary storage rollers 31, 34 towards the inside of the rotatable member, substantially forming the vertices of a quadrilateral with the second and third temporary storage rollers 32, 33, which instead have a fixed position on the rotatable member 40. At the center of this quadrilateral, the winding mandrel 41 is arranged, formed in a known way by two semi-cylindrical halves designed to be alternately moved close to each other and away one from another.

To associate the tape materials 10 with the winding mandrel 41, an appropriate angular rotation is carried out of the vacuum blades 25 for gripping the free end of the portions of given length of the separator tapes 11, 13, wound on the first and third temporary storage rollers 31, 33, so as to arrange the same free ends in a position of mutual alignment, along a straight line tangent to the separator tapes wound on the temporary storage rollers 30.

In this step of arranging the separator tapes 11, 13, the winding mandrel 41 is arranged in a retracted position, with the two semi-cylindrical halves arranged in a spaced position. Once the free ends of the tapes 11, 13 of the dielectric material have been aligned, the winding mandrel 41 is moved to an advanced position, so as to engage the free ends of the separator tapes 11, 13, still retained by the respective vacuum gripping blades 25, between the two semi-cylindrical halves. The two semi-cylindrical halves of the winding mandrel 41 are then brought closer to tighten the free ends of the separator tapes 11, 13.

The operation in rotation of the winding mandrel 41, in suitable phase relationship with the release of the separator tapes 11, 13 by the vacuum gripping blades 25 makes the winding of the tapes start.

At the same time, the free ends of the anode and cathode tapes 12, 14, wound on the second and fourth temporary storage rollers 32, 34, are approached, by means of an angular rotation of the respective vacuum gripping blades 25, to the rotating winding mandrel 41. In this way, the anode and cathode tapes 12, 14 are also associated with the winding mandrel 41, in positions interposed between the separating tapes 11, 13.

At the end of the winding step of the tape elements 10 on the winding mandrel 41, which extends for example by a rotation of the rotating member 40 of about half a turn, the superimposed tapes 10 wound in a cylindrical shape are fixed by the application of a portion of adhesive tape.

The cylindrical cell 100 so created is subsequently released into an unloading zone on special removal means 43.

After the unloading of the produced cylindrical cell 100, the rotation of the rotating member 40 brings the group of temporary storage rollers 30 at the loading station 46 of the adhesive tape. Upon passage at this loading station 46, a portion of adhesive tape is taken from one of the storage rollers of the group of temporary storage rollers 30 and arranged for creating next cylindrical cell.

The method allows an optimal winding of the superimposed tape elements forming the anode, the cathode and at least one separator element, in particular ensuring the achievement of a high production speed in the production of cylindrical cell electric batteries and the like.

This result is achieved thanks to the inventive idea of winding the tape elements forming the anode, the cathode and at least one separator element on a group of respective temporary storage rollers which subsequently feed the winding mandrel, to form a cylindrical cell.

In particular, the presence of a plurality of groups of temporary storage rollers makes it possible to complete the winding on a winding mandrel of the respective portions of given length of said tape elements, unwinding from a group of temporary storage rollers, while at the same time further respective portions of given length of tape elements are wound on a further group of temporary storage rollers.

According to the preferred embodiment of the invention, the machine for manufacturing electrical energy storage devices, such as for example cylindrical cell electric batteries and the like, is equipped with a plurality of groups of temporary storage rollers carried peripherally by a rotatable member, in regularly distributed positions, so as to perform in succession the winding of successive portions of given length of tape elements.

The rotatable member is operated in rotation with continuous motion so as to bring each group of temporary storage rollers in succession at the exchanger rollers, to receive the tape materials forming the anode, the cathode and at least one separator element; transferring said tape elements to a winding mandrel carried by the same rotatable member and winding the same tape elements onto said winding mandrel; unloading the cylindrical cell thus made so as to prepare the group of temporary storage rollers for a new operating cycle.

In the illustrated case, the rotatable member carries six groups of temporary storage rollers. However, it is evident that it is possible to provide a different number of groups of temporary storage rollers according to production requirements. In particular, the number of groups of temporary storage rollers is in relation to the diametrical dimensions of the rotatable member.

This solution allows to perform the winding of the tape forming the anode, the cathode and the separator elements, unwound from a group of temporary storage rollers, on a relative winding mandrel, simultaneously, namely in the time in which corresponding portions of given length of the belt elements are wound on successive groups of temporary storage rollers.

The number of groups of temporary accumulation rollers operating simultaneously obviously depends on the diametrical dimensions of the rotatable member. In the case illustrated purely as an example, in the time in which the tape elements are wound on the winding mandrel, essentially corresponding to half a turn of the rotatable member, respective portions of given length of the tape elements are wound on four successive groups of temporary storage rollers.

Obviously, the possibility of performing in sequence the simultaneous winding of a plurality of cylindrical cells, on respective winding mandrels, in itself determines a significant increase in the productivity of the machine. In practice, the number of cylindrical cells that can be made in the unit of time increases proportionally.

It should be noted that the time in which the winding of the cylindrical tape elements on the winding mandrel is completed, as described above, is determined by the peripheral speed of the rotatable member, as well as by the rotation speed of the winding mandrel.

A longer winding time, with the same size and rotation speed of the winding mandrel, permits to wind on the winding mandrel portions of tape elements having a greater length than in the known art. In other words, the limit due, in the known art, to the reduced radial dimensions of the winding mandrel is exceeded.

In practice, it has been found that the machine described is capable of producing about 100 cylindrical cells per minute having a portion of superimposed tape of 3 m length.

A prerogative of the invention is the fact that the tape elements constituting the anode, the cathode and the separator elements of the cylindrical cell electric batteries are carried out with continuous motion from the respective reels.

This is made possible, according to the present invention, thanks to the creation of a mechanical loop on the tape elements constituting the anode, the cathode and the separator elements fed by the respective reels, upstream of the transfer to the rotating winding member of the individual cells. This loop of the tape elements forms a variable reserve portion of each tape capable of compensating for a different feeding speed of the same tape. In particular, it is possible to temporarily stop the feeding of the tape elements to the rotating winding member of the individual cells, downstream of the buffers, to allow the group of temporary storage rollers to be changed, while continuing the unwinding of the tape elements from the respective reels with continuous motion.

The machine described as an example is susceptible of numerous modifications and variations according to the various requirements.

In the practical embodiment of the invention, the materials used, as well as the shape and the dimensions, may be modified depending on needs.

Should the technical features mentioned in any claim be followed by reference signs, such reference signs were included strictly with the aim of enhancing the understanding of the claims and hence they shall not be deemed restrictive in any manner whatsoever on the scope of each element identified for exemplifying purposes by such reference signs.

1. A method for manufacturing devices for storing electrical energy, comprising the steps of
a. feeding with continuous motion a plurality of tape elements, forming at least one anode, one cathode and one separator element interposed between said anode and cathode;
b. winding said tape elements on respective temporary storage rollers;
c. cutting to given length respective portions of said tape elements wound on said temporary storage rollers;
d. arranging said temporary storage rollers carrying said respective portions of given length of said tape elements at a winding mandrel having a rotation axis arranged parallel to the respective axes of the same temporary storage rollers
e. associating a free end of said portions of given length of said tape elements to said winding mandrel;
f. rotating said winding mandrel to wind said portions of given length of said tape elements superimposed on each other, on the same winding mandrel;
g. finishing the winding of said portions of given length of the tape elements superimposed on said winding mandrel to form a cell of the electrical energy storage device, until said portions of given length of said tape elements are completely wound off said temporary storage rollers.

2. The method of claim 1, wherein said step of arranging said temporary storage rollers at said winding mandrel provides for moving at least a part of said temporary storage rollers from a position moved away from said winding mandrel, in which said tape elements are wound onto said respective temporary storage rollers, to a position close to the winding mandrel

3. A method of claim 1, wherein said step e. provides for
e1. initially associating to said winding mandrel a free end of said portion of given length of at least one said tape element forming a separator element; and
said step f. provides for
f1. rotating said winding mandrel to start the winding of said portion of given length of at least one said tape element forming a separator element on the same winding mandrel;
f2. associating said winding mandrel with the free ends of said portions of given length of said tape elements forming at least one anode and one cathode.

4. A machine for manufacturing devices for storing electrical energy, comprising
means for feeding with continuous motion a plurality of tape elements, forming at least one anode, one cathode and one separator element interposed between said anode and cathode;
at least one group of temporary storage rollers capable of receiving and winding respectively said tape elements fed by said feeding means;
means for cutting to size respective portions of given length of said tape elements wound on said temporary storage rollers;
at least one winding mandrel having an axis of rotation parallel to the axes of said temporary storage rollers and rotatable to wind said portions of given length of said tape elements, said tape elements being superimposed on each other;
means for arranging said temporary storage rollers at said winding mandrel;
means for associating a free end of said portions of given length of said tape elements to said winding mandrel, to wind said portions of given length of said superimposed tape elements in cylindrical manner;
means for discharging the cell of the device for storing electrical energy manufactured in this manner.

5. The machine of claim 4, wherein said winding mandrel comprises a pair of bodies of complementary shape capable of being alternately moved near and away from each other between a spaced position for inserting inside them a free end of at least one of said portions of given length of said tape elements and an approached position to clamp said free end of said at least one of said portions of given length of the tape elements, before rotating the same winding mandrel to wind the tape elements.

6. The machine of claim 5, wherein said pair of bodies of complementary shape comprises a pair of semi-cylindrical bodies having opposed flat surfaces capable of being clamped one against another in said approached position.

7. A machine of claim 4, wherein said cutting to size means is capable of cooperating with respective exchanger rollers capable of receiving said tape elements from said feeding means and transferring the same tape elements respectively to said temporary storage rollers, said exchanger rollers respectively having a pair of areas placed under vacuum, suitable for holding respective free ends of said tape elements placed upstream and downstream of the cutting line defined by said cutting to size means, following the cutting of said portions of given length of the same tape elements.

8. The machine of claim 7, wherein said means suitable for arranging said temporary storage rollers at said winding mandrel comprises gripping members 5 arranged respectively at said exchanger rollers and movable between a gripping position of said free ends of said portions of given length of the tape elements placed downstream of the cutting line defined by said cutting to size means and a position of release of the same free ends to said winding mandrel.

9. The machine of claim 4, wherein said temporary storage rollers have a respective gripping area placed under vacuum and suitable for retaining the head end of said tape elements to be wound.

10. The machine of claim 4, wherein it comprises, downstream of said feeding means, buffer devices capable of housing respectively a variable reserve portion of said tape elements, each of said buffer devices comprising a pair of surfaces, developed one in front of the other to guide the unwinding of said respective tape elements forming a loop therebetween and associated with suction means capable of depressing a portion of the surfaces, to hold adherently the tape elements sliding thereon.

11. The machine of claim 4, wherein said winding mandrel is rotatable to wind in a cylindrical manner said portions of given length of said superimposed tape elements.
